(19) United States
(12) Patent Application Publication
(10) Pub. No.: US 2006/0162160 A1
(43) Pub. Date: Jul. 27, 2006

(54) Gas removal method and apparatus for heat pipe

(76) Inventor: Hul-Chun Hsu, Taichung City (TW)

Correspondence Address: HDSL, 4331 STEVENS BATTLE LANE, FAIRFAX, VA, 22033, US

(21) Appl. No.: 11/043,101

(22) Filed: Jan. 27, 2005

(51) Int. Cl. B23P 6/00

(52) U.S. Cl. 29/890.032; 261/2

(57) ABSTRACT

A method and an apparatus for removing gas from a heat pipe. A working fluid is filled in the tubular member of the heat pipe, and the heat pipe is heated while being horizontally disposed or slanted with respect to the horizontal direction.

### BACKGROUND OF THE INVENTION

The present invention relates in general to a gas removal method and an apparatus for a heat pipe, and more particularly, to a method and an apparatus that heats up the heat pipe while disposing the tubular member of the heat pipe horizontally or in a slanted orientation with respect to the horizontal direction.

Having the features of high heat transmission capability, high speed of heat transmission, high thermal conductivity, light weight, active-device-less, simple structures and versatile applications, heat pipes can deliver massive amount of heat without causing power consumption. Therefore, heat pipes have been broadly applied in electronic products. Typically, the heat pipe includes a wick structure attached to an internal sidewall of the heat pipe. The wick structure includes a woven mesh having capillary function, which is advantageous to transportation of the working fluid.

Typically, the gas removal process of the heat pipes is performed by heating up the heat pipes disposed vertically, such as disclosed in Taiwan patent application No. 593961. As the heat pipes are normally configured into elongate tube, the surface level of the working liquid is always higher than the bottom of the tube when the heat pipes are disposed vertically. Thereby, gas columns are easily formed within the working fluid during the heat process, particularly near the bottom of the tube. The gas columns often spray or spill the working fluid out of the tube to result in insufficient working fluid within the heat pipes.

### BRIEF SUMMARY OF THE INVENTION

A gas removal method and a gas removal method for a heat pipe are provided. The heat pipe includes a tubular member disposed horizontally or slanted with respect to the vertical direction, and a heating process is performed on the heat pipe to removal non-condensable gas from the tubular member. Thereby, a larger surface area of the working fluid is obtained to reduce the amount of gas columns formed within the working fluid. Further, as the depth of the working fluid is reduced, even when gas columns are formed, the height of the gas columns is decreased to resulting less momentum for spraying the working fluid. Further, as the gas columns are not aligned with the venting opening of the heat pipe, the working fluid is prevented from spraying out of the heat pipe.

According to the present invention, the gas removal method for a heat pipe includes: a) filling a working fluid into a tubular member of the heat pipe, and remaining one end of the heat pipe open for venting a non-condensable gas contained in the tubular member; b) disposing the tubular member off a vertical direction, and heating the working fluid to a saturation temperature thereof; and c) continuing the heating process until some of the working fluid vaporized to carry the non-condensable gas out of the tubular member through the venting end.

Furthermore, the gas removal apparatus for removing non-condensable gas from a heat pipe includes a tube carrier for supporting the heat pipe off a vertical orientation, a heating element disposed around a sidewall of the heat pipe, and a sealing element aligned with an open end of the heat pipe.

### BRIEF DESCRIPTION OF THE DRAWINGS

The above objects and advantages of the present invention will be become more apparent by describing in detail exemplary embodiments thereof with reference to the attached drawings in which:

FIG. 1 is a process flow of a gas removal method for a heat pipe;

FIG. 2 shows a heat pipe disposed horizontally for performing gas removal; and

FIG. 3 shows a heat pipe slanted with respect to a vertical direction (horizontal direction) for performing gas removal.

### DETAILED DESCRIPTION OF THE INVENTION

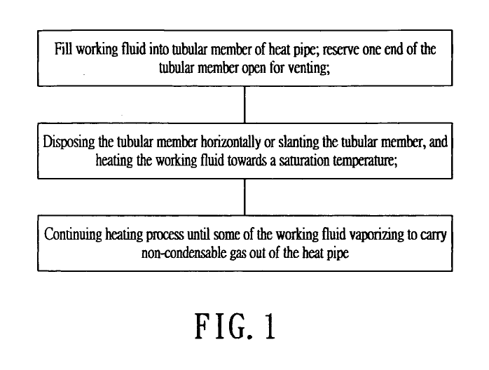

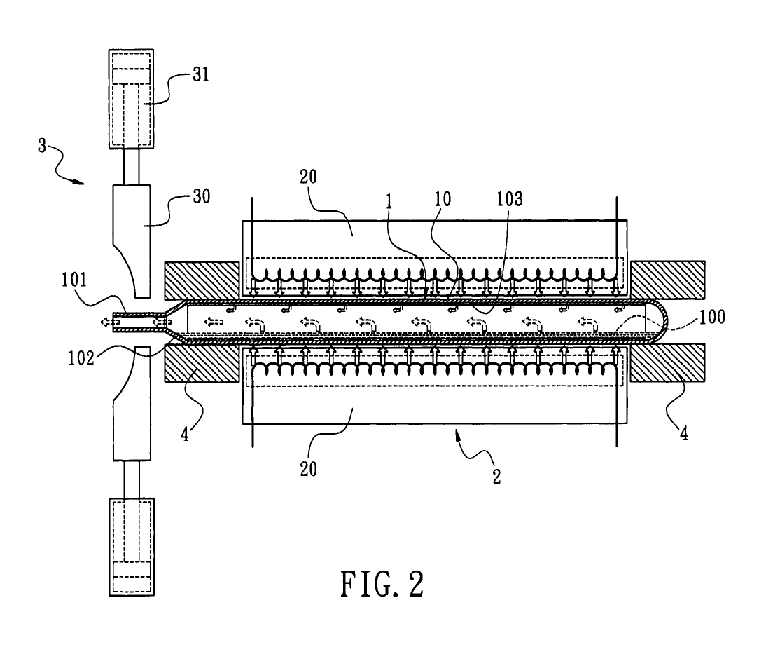

Referring to FIGS. 1 and 2, as provided, a heat pipe is disposed horizontally for performing a gas removal process.

The heat pipe 1 includes a tubular member 10 in which a predetermined amount of working fluid 100 is filled. One end of the tubular member 10 remains open allowing gas to vent therefrom.

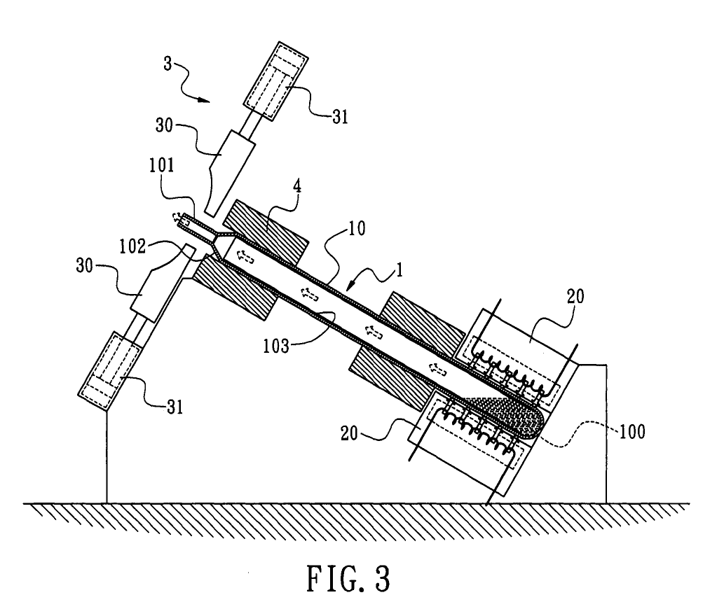

The tubular member 10 is supported by a tube support member 4. As shown in FIG. 2, the tubular member 10 is disposed horizontally. The tubular member 10 can also be slanted with respect to the horizontal or vertical direction as shown in FIG. 3 with the support of the support member 4. Preferably, the slanting angle of the tubular member 10 is about 15° or 30° with respect to the horizontal direction. The working fluid 100 is heated up to a saturation temperature. The horizontal and slanted arrangements of the tubular member 10 reduce the possibility of forming gas columns within the working fluid 100 during the heating process. In addition, the venting end of the tubular member 10 includes a gradually shrunk bottleneck region 102. Therefore, when the tubular member 10 is disposed horizontally, the working fluid 100 is prevented from flowing out of the tubular member 10 through the venting end 101. A wick structure 103 is attached to internal wall of the tubular member 10. During the heating process, the working fluid can be uniformly absorbed by the wick structure 102 to result in a uniform heating effect. Further, the working fluid 100 absorbed by the wick structure 102 is wide spread over the internal wall of the tubular member 100, such that the surface area of the working fluid 100 is larger than that in the vertically disposed heat pipe. This further suppresses formation of gas columns.

The saturation temperature of the working fluid is maintained until the working fluid 100 reaches boiling and vaporizing state. The non-condensable gas (as shown by the arrows in FIG. 2) is thus carried by the vapor of the working fluid 100 and expelled out of the tubular member 100. Preferably, the heating process is performed gently to avoid the working fluid 100 to spray out of the tubular member 10, so as to control the remaining amount of the working fluid 100 precisely. However, under the circumstance that the remaining amount of the working fluid 100 is not critical, the heating process can be performed more actively to speed up the gas removal process.

When the expelled working fluid vapor reaches a predetermined amount, or when the heating process is performed for a predetermined period of time, the venting end 101 is sealed. For example, the venting end 101 can be sealed by supersonic welding to provide an improved sealing effect.

As discussed above, the structure of the gas removal apparatus includes a tube carrier 4 allowing the tubular member 10 disposed horizontally or slanted with respect to the horizontal direction. The tubular member 10 is surrounded by a heating element 2 for uniformly heating the working fluid 100 within the tubular member 10. One end of the tubular member 10 remains open to serve as a venting end 101 from which the non-condensable gas is expelled. Further, as shown in FIGS. 2 and 3, the venting end 101 has a much smaller diameter compared to the main body of the tubular member 10. Between the venting end 101 and the main body, the tubular member 10 is gradually contracted to form a bottleneck region 102 that prevents the working fluid 100 to flow out of the tubular member 10.

The heat element 2 includes a heating device 20 that can control the amount of thermal energy and the temperature applied to the working fluid 100 via the tubular member 10. The heating element 2 extends along the elongate direction of the tubular member 10 to cover sufficient area of thereof.

As shown in FIGS. 2 and 3, a pair of molds 30 and a pair of sealing mechanism 31 controlling the movement of the molds 30 are disposed at two opposing sides of the venting end 101. When the gas removal process is complete, the sealing mechanisms 31 drive the molds 30 to press the venting end 101 to seal. Preferably, the molds 30 also include a heating element to ensure the temperature around the venting end 101 no less than the saturation temperature of the working fluid 100. Thereby, the working fluid vapor will not condense at the venting end before being expelled from the tubular member 10.

By horizontally disposing or slanting the tubular member 10, the surface level of the working fluid 100 is very close to the internal wall of the tubular member 10, such that formation of the gas columns is effectively suppressed. Even when some gas columns occur, the working fluid 100 will not be sprayed out of the tubular member 10 by the gas columns.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A gas removal method for a heat pipe, comprising:
a) filling a working fluid into a tubular member of the heat pipe, and remaining one end of the heat pipe open for venting a non-condensable gas contained in the tubular member;
b) disposing the tubular member off a vertical direction, and heating the working fluid to a saturation temperature thereof; and
c) continuing the heating process until some of the working fluid vaporized to carry the non-condensable gas out of the tubular member through the venting end.

2. The method of claim 1, further comprising forming a gradually contracting region between a main body of the tubular member and the venting end.

3. The method of claim 1, wherein the saturation temperature is a boiling point of the working fluid.

4. The method of claim 1, wherein step (b) further comprises providing a heating element surrounding the tubular member to uniformly heat up the working fluid through the tubular member.

5. The method of claim 1, wherein further comprising a step of sealing the venting end of the tubular member when the non-condensable is expelled from the tubular member.

6. The method of claim 5, wherein the sealing step includes a supersonic welding process.

7. The method of claim 1, wherein step (b) includes disposing the tubular member horizontally.

8. The method of claim 1, wherein step (b) includes slanting the tubular member by an angle with respect to a horizontal direction.

9. The method of claim 8, wherein the angle is 15°

10. The method of claim 8, wherein the angle is 30°.

11. The method of claim 1, further comprising a step of attaching a wick structure to an internal wall of the tubular member, and using the wick structure to absorb the working fluid and uniformly spread the working fluid over the internal wall of the tubular member.

12. The method of claim 1, further comprising a step of maintaining an ambient temperature around the venting end higher than the saturation temperature.

13. A gas removal apparatus for removing non-condensable gas from a heat pipe, comprising:
a tube carrier for supporting the heat pipe off a vertical orientation;
a heating element disposed around a sidewall of the heat pipe; and
a sealing element aligned with an open end of the heat pipe.

14. The apparatus of claim 13, wherein the tube carrier is operative to support the heat pipe oriented to a horizontal position.

15. The apparatus of claim 13, wherein the tube carrier is operative to support the heat pipe oriented to a slanted position.

16. The apparatus of claim 13, wherein the slanted position includes a position with 15° or 30° with respect to a horizontal direction.

17. The apparatus of claim 13, wherein the heating element includes a heating device surrounding the sidewall of the heat pipe to provide uniform heating effect of the heat pipe.

18. The apparatus of claim 13, wherein the sealing element includes a heating element to maintain a predetermined temperature at the open end of the heat pipe.

19. The apparatus of claim 13, wherein the heating element is supported by the tube carrier.

20. The apparatus of claim 13, wherein the sealing element includes a pair of mold operative to press the open end of the heat pipe to seal.
